(19) United States
(12) Patent Application Publication
(10) Pub. No.: US 2013/0086140 A1
(43) Pub. Date: Apr. 4, 2013

(54) CLOUD MANAGEMENT SYSTEM AND METHOD

(71) Applicant: Michael A. Salsburg, Phoenixville, PA (US)

(72) Inventor: Michael A. Salsburg, Phoenixville, PA (US)

(21) Appl. No.: 13/248,076

(22) Filed: Sep. 29, 2011

(51) Int. Cl. G06F 15/16

(52) U.S. Cl. 709/203

(57) ABSTRACT

An information technology system having a cloud resource management including a first interface. One or more clouds are connected to the resource management unit. Each cloud has a corresponding second interface adapted to provide a service to a user of the information technology system. The cloud resource management unit further including a first storage unit adapted to store first information required to convert a request for the service from the user in the first interface to a request suitable for the second interface of the corresponding at least one cloud.

### CROSS REFERENCE

This application is related to U.S. patent application Ser. No. 13/248,070, entitled “Cloud Management System and Method,” filed on Sep. 29, 2011.

### TECHNICAL FIELD

The present invention relates generally to a system for management of information technology systems.

### BACKGROUND

Cloud computing enables convenient, on-demand network access to a shared pool of configurable computing resources, for example, networks, servers, storage, applications, and services that can be rapidly provisioned and released with minimal human managerial effort or service provider interaction. For one or more end-users that are attached to the shared pool of configurable computing resources that comprise a cloud, cloud computing provides computation, applications, data access, and storage services for the end-user. The end-user does not require knowledge of the physical location and configuration of the system that delivers the services. Further, the end-user is able to pay for the computation, applications, data access, and storage services based on the amount of usage rather than having to purchase and manage dedicated computation, applications, data access, and storage resources.

Clouds are developed as stand-alone platforms and include hardware and applications necessary to perform required services for the end-users. In some contexts, clouds are known as platforms. The term “cloud” for the purpose of this application also encompasses the term “platform.” The term “off-site cloud” is used to refer to a public cloud, which is a cloud that is accessible on the Internet. The term “in-house cloud” is used to refer to a private cloud, which is not generally accessible on the Internet.

Examples of the services include software as a service (“SAAS”), platform as a service (“PAAS”), and infrastructure as a service (“IAAS”). In SAAS, users pay a fee, on a recurring basis, to access and use specific applications. In PAAS, the user leases access to an entire platform, for example, a customer resource management platform. In IAAS, the user leases access to certain infrastructure, for example, a physical or virtual server with particular computational and/or storage capabilities.

The above clouds do not address several issues with using such clouds in corporate, government or similar complex environments. In the corporate environment, for example, it is advantageous to be able to connect to multiple off-site and in-house clouds simultaneously and optionally link aspects of the clouds together. Some corporate services are provided by a first cloud optimized to provide that service, for example, human resource services. Other corporate services, for example, payroll services are performed on a second cloud optimized to provide that service. It is advantageous, however, if some services in the payroll cloud can access services provided by the human resource cloud. To pass data between the above clouds requires that the different clouds are setup and programmed to communicate with each other. Some services can be provided by more than one general purpose cloud, the decision as to which cloud depending on the current usage of each cloud and cost of using each of the general purpose clouds.

Further, in the corporate environment, for example, not all corporate services are provided by a cloud. Some services such as core services and legacy services of the corporation may be kept in-house and provided by dedicated hardware because these services embody a competitive advantage of the corporation. Other services may be kept on dedicated hardware because of the sensitive nature of the data or processes the services embody. Yet other services may be provided by dedicated hardware because these services are a part of security and protection for the corporate environment, for example, authentication services, firewalls and anti-malware, and virus services. Some services are too data intensive to reliably be provided by a cloud. Therefore, it is advantageous to have a hybrid information technology (IT) enterprise with some services provided by dedicated hardware, some provided by in-house clouds and some services provided by off-site clouds.

The above fragmentation of resources means that both users and administrators are faced with numerous different interfaces, and attributes that must be used and maintained in the various clouds and dedicated hardware. The dedicated hardware, in-house clouds and off-site clouds are better managed as a part of a general overall IT solution. Current in-house clouds and off-site clouds do not allow the corporate IT infrastructure to be managed together. Moreover, a corporation does not wish to be tied too deeply to a particular cloud whether in-house or off-site.

If the cost of switching the provider of the particular cloud becomes prohibitive then the corporation is no longer able to use competition to drive down prices for the services provided by the particular cloud.

### SUMMARY

The systems and methods described herein attempt to overcome the drawbacks discussed above by providing an IT system management (ITSM) that includes the processes and governance policies into which the above discussed resources are integrated and managed. The system comprises a cloud resource management unit that allows management of a hybrid enterprise comprising a data center, one or more in-house and one or more a off-site clouds from a single point in the hybrid enterprise. The cloud resource management unit allows management of and provisioning for applications that span one or more portions of the data center, the one or more in-house and the one or more off-site clouds from a single point in the hybrid enterprise. The cloud resource management unit allows self-provisioning of services on the one or more in-house clouds and the one or more a off-site clouds from a single point in the hybrid enterprise without requiring the requester to know which of the one or more in-house clouds and the one or more a off-site clouds are used to provide the services requested.

In one embodiment, an information technology system comprising a cloud resource management unit comprising a first interface. At least one cloud connected to the cloud resource management unit, each cloud comprising a corresponding second interface adapted to provide a service to a user of the information technology system. The cloud resource management unit further comprising a first storage unit adapted to store first information required to convert a request for the service from the user in the first interface to a request suitable for the corresponding second interface of the at least one cloud.

In one embodiment, a method of providing a service on an information technology system comprising connecting at least one cloud to a cloud resource management unit. The cloud resource management unit receiving a request for a service from a user using a first interface. The cloud resource management unit storing first information required to convert the request for the service from the user using the first interface to a request suitable for a second interface of the corresponding at least one cloud to provide the service.

### BRIEF DESCRIPTION OF THE DRAWINGS

The accompanying drawings constitute a part of this specification and illustrate an embodiment of the invention and together with the specification, explain the invention.

FIG. 1 illustrates a corporate IT system connected to the Internet.

FIG. 2 illustrates the hardware used by one of the in-house clouds.

FIG. 3 illustrates attributes that are managed by the cloud management unit.

FIG. 4 illustrates a corporate IT system with a cloud resource management unit for managing cloud management units of multiple in-house and off-site clouds.

FIG. 5 illustrates a cloud resource management unit for managing cloud management units of multiple in-house and off-site clouds.

FIG. 6 illustrates a method of configuring a corporate IT system.

FIG. 7 illustrates a method of providing a service to a user on the corporate IT system.

### DETAILED DESCRIPTION

Reference will now be made in detail to the preferred embodiments, examples of which are illustrated in the accompanying drawings.

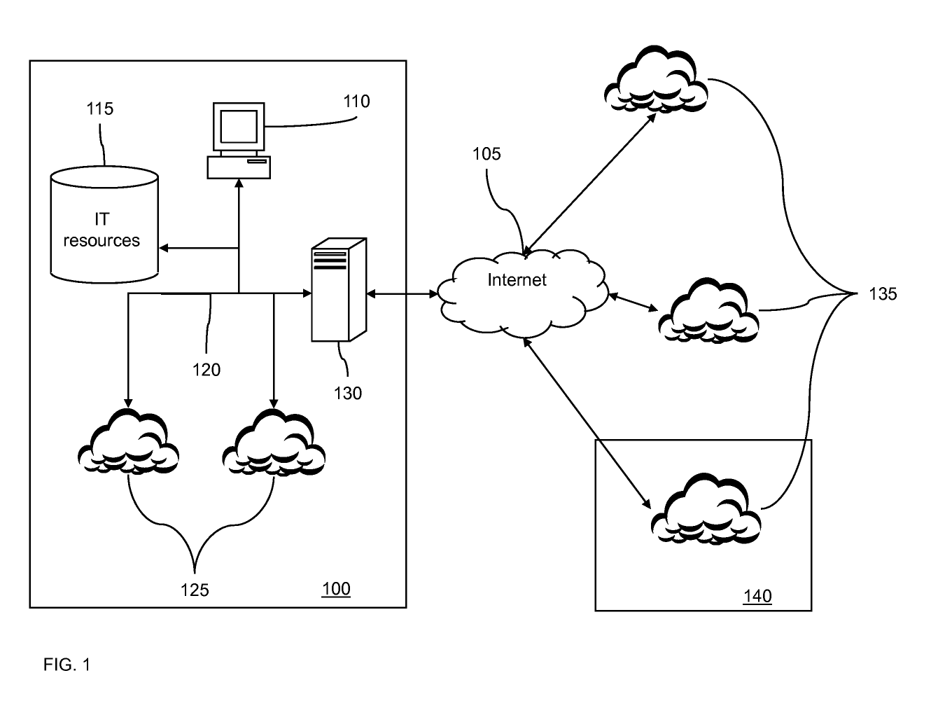

FIG. 1 illustrates a corporate IT system 100 connected to the Internet 105. A user 110 in the corporate IT system 100 is connected to IT resources 115 in the corporate IT system 100. The corporate IT system 100 is part of a corporation, government organization, non-profit, or any other entity that uses an IT infrastructure. The IT resources 115 include, for example, servers, databases, printers, storage, backup, gateways to other systems and security systems. The user 110 is able to access and use the IT resources 115 to perform services for the corporation.

The IT resources 115 are connected by one or more computer networks 120. Also attached to the network 120 are one or more in-house clouds 125. The in-house clouds 125 are used in addition to or instead of the IT resources 115 to perform services for the corporation.

For the purpose of this application clouds include platforms or systems that provide services including one or more of software as a service (“SAAS”), platform as a service (“PAAS”), and infrastructure as a service (“IAAS”). The platforms or systems include the hardware, such as servers, computers, data storage systems, communication equipment, software applications and infrastructure required to deliver the SAAS, PAAS or IAAS to one or more users attached to the cloud via a data network. Clouds can be in-house or private meaning the cloud is only accessible to users behind a firewall of an institution along with the cloud and provides one or more of SAAS, PAAS or IAAS to the users. An in-house or private cloud may also be accessible to users outside the firewall of the institution via a virtual private network (VPN) connection. An in-house or private cloud also includes platforms that are not attached to the internet and provide SAAS, PAAS or IAAS to users. An in-house cloud can also have built in security, controlling access to the in-house cloud and preventing users from interfering with one another. Such an in-house cloud may also be known as a secure private cloud (SPC). Public clouds include platforms that provide one of SAAS, PAAS or IAAS to users via the internet, or some other public network such as WiFi or mobile phone networks.

The user 110 is, for example, a person controlling a computer. The user 110 can also be an administrator of the corporate IT system 100. Furthermore, the user 110 can be an application running on a computer. The application can be running on a computer forming any of the IT resources 115, in-house clouds 125.

The user 110 can also use resources external to the corporate IT system 100. Referring to FIG. 1, the corporate IT system 100 is connected to a gateway 130. The gateway 130 is connected to the Internet 105. The Internet 105 provides connections to off-site clouds 135. In some embodiments, the off-site clouds 135 are a part of a separate organization. In other embodiments, the off-site clouds are a separate portion of the corporation 140. The user 110 is able to access the off-site clouds 135 via the gateway 130 and the Internet 105. The gateway 130 includes various features that keep the corporate IT system 100 private and secure from other users attached to the Internet 105. The features include, for example, firewalls and scanners for viruses and malware.

Thus, the user 110 has access to multiple resources, each of the resources providing a corresponding set of services to the user 110 via one or more interfaces and/or protocols with corresponding security and access features.

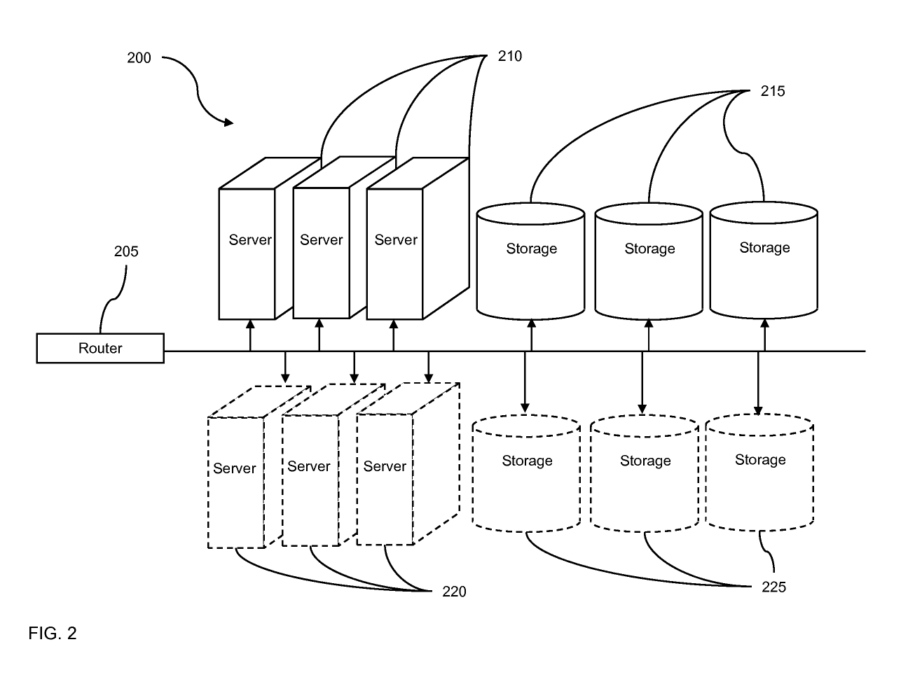

FIG. 2 illustrates the hardware 200 used by one of the in-house 125 or off-site clouds 135 to provide services to the user 110. The hardware 200 comprises a router 205, servers 210 and storage or database systems 215. The router 205 is connected to a network accessible by the user 110. The composition of the hardware 200 used by one of the in-house 125 or off-site clouds 135 is not limited to the above router 205, servers 210 and storage or database systems 215. Any combination of devices compatible with embodiments of the disclosure may form a portion of the hardware 200 and is within the scope of this disclosure.

The servers 210 and storage or database systems 215 may also be used to define virtual servers 220 and virtual storage or database systems 225. The user 110 connects to the in-house clouds 125 via the router 205 and accesses services provided by the servers 210, virtual servers 220, storage or database systems 215 and virtual storage or database systems 225. In some embodiments, the user 110 is not aware if the services are provided by virtual portions or non-virtual portions of the hardware 200. Further, in some embodiments the user 110 is not aware of the numbers or performance of the portions of the hardware 200 used to provide the services.

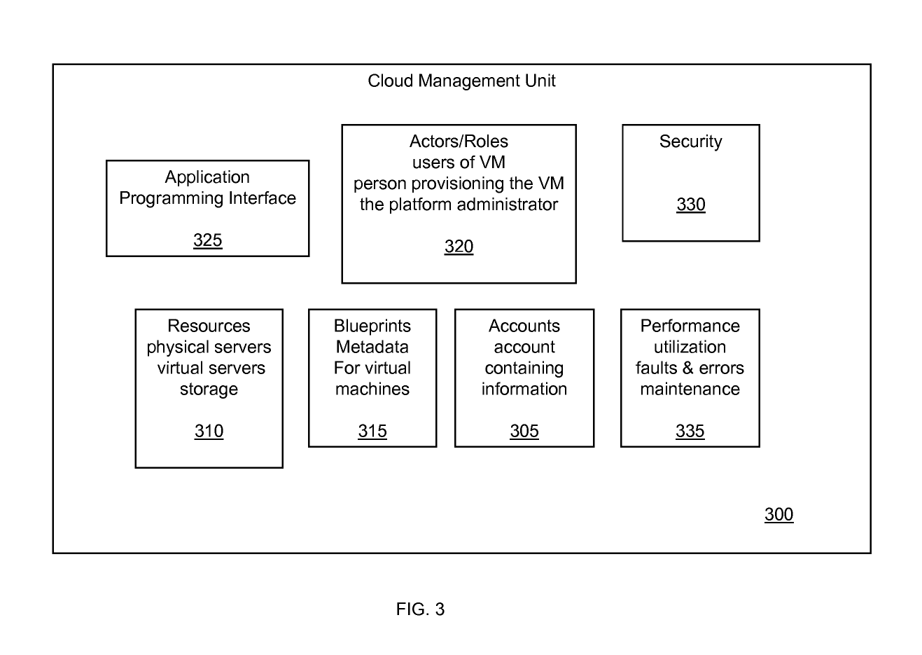

The in-house clouds 125 comprise a cloud management unit (shown as cloud management unit 300 in FIG. 3) designed specifically for the management of a corresponding in-house cloud 125. The cloud management unit 300 is implemented on a server or computer having a general purpose processing unit either within the corresponding in-house clouds 125 or in a server attached to the corresponding in-house cloud 125. Alternatively, in some embodiments, the cloud management unit 300 is implemented in dedicated hardware. FIG. 3 illustrates attributes that are managed by the cloud management unit 300. When a user 110 connects to the in-house cloud 125, the cloud management unit 300 compares the user 110 to account attributes 305 of the cloud management unit 300. For each user 110 accessing the in-house cloud 125, account information is stored regarding, for example, agreements containing some minimum and/or maximum number of resources that the user 110 can use and the times that the user 110 is allowed to use the resources. The account attributes 305 of each user 110 can be updated by a system administrator as required.

Resources are provisioned to the user 110 by consulting and updating the resource attributes 310 of the cloud management unit 300. The resource attributes 310 contain details of the servers 210 and storage or database systems 215 contained in the hardware 200. Further, the resource attributes 310 contain details regarding how portions of the servers 210 and storage or database systems 225 are assigned to users 110. In some embodiments, the user 110 self-provisions the resources using the cloud management unit 300. In other embodiments, the resources are provisioned by an IT manager, or by an automated provisioning system. The user 110 can be provisioned with any combination of servers 210, storage and database systems 215 and/or virtual servers 220 and virtual storage or database systems 225.

The definitions for virtual servers 220 and the virtual storage or database systems 225 are stored in blueprint attributes 315 of the cloud management unit 300. Using the blueprint attributes 315 the user 110 can choose appropriate virtual servers 220 and virtual storage or database systems 225 for providing the services required. The blueprint attributes 315 indicate, for example, how much memory is assigned to each virtual server 220, the speed of a CPU of each virtual server 220, the type of CPU for each virtual server 220, the operating system to run by each virtual server 220, any application software to be run by each virtual server 220 and any ports or resources such as printers, modems, network access, or any other resources available to each virtual server 220. The blueprint attributes 315 can be administered by an administrator.

The cloud management unit 300 further comprises actor/role attributes 320. The actor/role attributes 320 define for each user 110 the role and authority of the corresponding user 110. For example, some users have administrator rights and are able to control the access and rights of other users. Some users are only users of services provided by the cloud management unit 300. The actor/role attributes 320 may also give access rights to particular applications running on any one of the in-house clouds 125 or any other computer or server in the corporate IT system 100.

The cloud management unit 300 further comprises security attributes 330. The security attributes may, for example, augment the access rights in the actor/role attributes 320 with additional constraints, by not allowing particular combinations of services to be performed, or by forcing additional services to be performed. Thus, for example, the security attributes may force a virus scan on all data entering the cloud, or prevent the execution, storing or deletion of various kinds of files or data.

The cloud management unit 300 further comprises performance attributes 335. The performance attributes allow, for example, the utilization of the in-house cloud 125 to be determined. The utilization includes the number of servers 210 and virtual servers 220 currently in use, and the amount of storage remaining in the storage or database systems 215 and virtual storage or database systems 225. The performance attributes may also include faults and errors currently occurring in the in-house cloud 125 as well as any current or scheduled maintenance for the in-house cloud 125.

The cloud management unit 300 further comprises application programming interfaces (APIs) 325 that can be called by a user 110 or an application running on the corporate IT system 100. When called, functions defined by the APIs 325 cause the cloud management unit 300 to perform various services. The APIs 325 form a consistent interface between the user 110 and the cloud management unit 300, independent of the specific hardware 200 and applications used to implement the in-house clouds. Thus, the hardware 200 of a specific in-house cloud 125 can be reconfigured, and the user 110 sees the same APIs 325 for the reconfigured in-house cloud 125. Different in-house clouds 125 may have different APIs. Therefore, a user 110 dealing directly with a particular in-house cloud 125 may have to adapt to the different APIs running on each in-house cloud 125. Further, an application attempting to use a particular in-house cloud 125 directly may have to adapt to the different APIs running on each in-house cloud 125.

The off-site clouds 135 may have similar attributes and APIs to the attributes and APIs discussed above for the in-house clouds 125. However, being off-site, and therefore, designed managed and maintained by different entities, the specific attributes and APIs of the off-site clouds 135 may be quite different and not compatible with the attributes 305, 310, 315, 320, 330, 335 and APIs 325 of the in-house clouds 125. In some embodiments, the off-site clouds may have no APIs available. Therefore, a user 110 dealing directly with a particular off-site cloud 135 may have to adapt to the different APIs running on each off-site cloud 135. Further, an application attempting to directly use a particular off-site cloud 135 may have to adapt to the different APIs running on each off-site cloud 135.

In some embodiments, IT resources 115 may also have similar sets of attributes 305, 310, 315, 320, 330, 335 and APIs 325. In other embodiments, IT resources 115 may lack one or more similar sets of attributes 305, 310, 315, 320, 330, 335 and APIs 325.

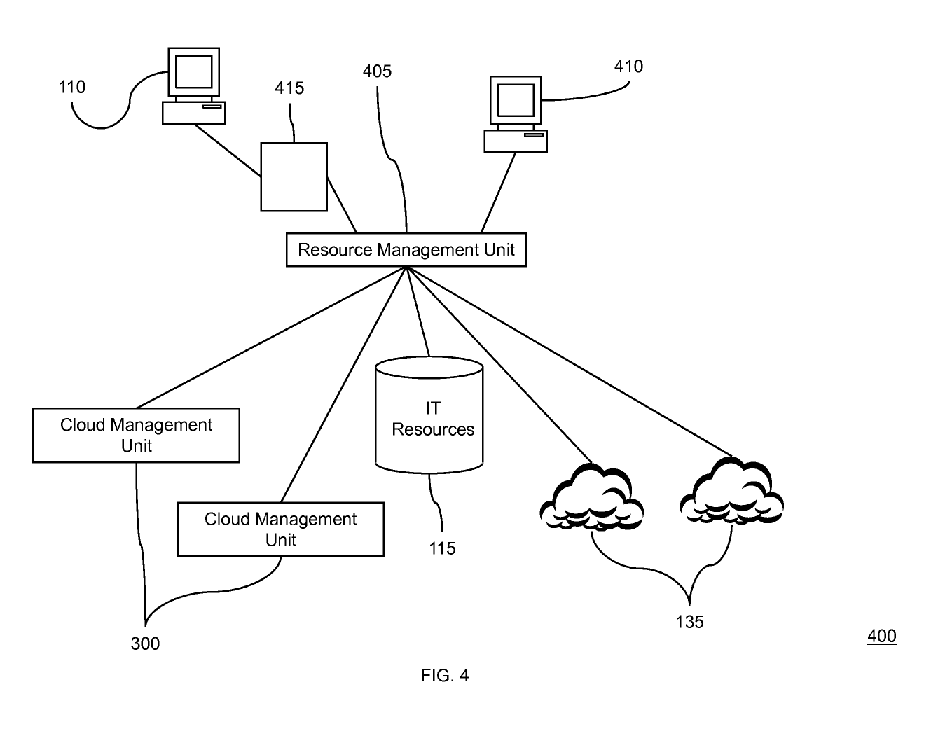

FIG. 4 illustrates a corporate IT system 400 including cloud resource management unit 405 for managing the multiple resources 115, the platform management units 300 of multiple in-house clouds 125 and multiple off-site clouds 135. The cloud resource management unit 405 forms the core of an IT system management (ITSM) system that includes the processes and governance policies to integrate and manage the multiple resources 115, multiple in-house clouds 125 and multiple off-site clouds 135. The cloud resource management unit 405 may be located on any part of the network 120 accessible by the user 110 and the resources 115, 125, 135. In some embodiments, the cloud resource management unit 405 is implemented on a server or computer having a general purpose processing unit. Alternatively, in some embodiments, the cloud resource management unit 405 is implemented in dedicated hardware.

In a corporate IT system 400 including cloud resource management unit 405, the user 110 interfaces the in-house clouds 125, IT resources 115 and off-site clouds 135 via the cloud resource management unit 405 using a self-service portal 415. The self-service portal 415 may be located on any server or dedicated hardware that is connected to both the user 110 and the cloud resource management unit 405.

The cloud resource management unit 405 allows system administrators to manage multiple attached IT resources 115, multiple attached in-house clouds 125 and multiple attached off-site clouds 135 from a central user interface 410.

To manage each of the in-house clouds 125 the cloud resource management unit 405 uses a portion of the APIs 325 of the corresponding in-house cloud 125 to manipulate the attributes 305, 310, 315, 320, 330, 335 of the corresponding cloud management unit 300.

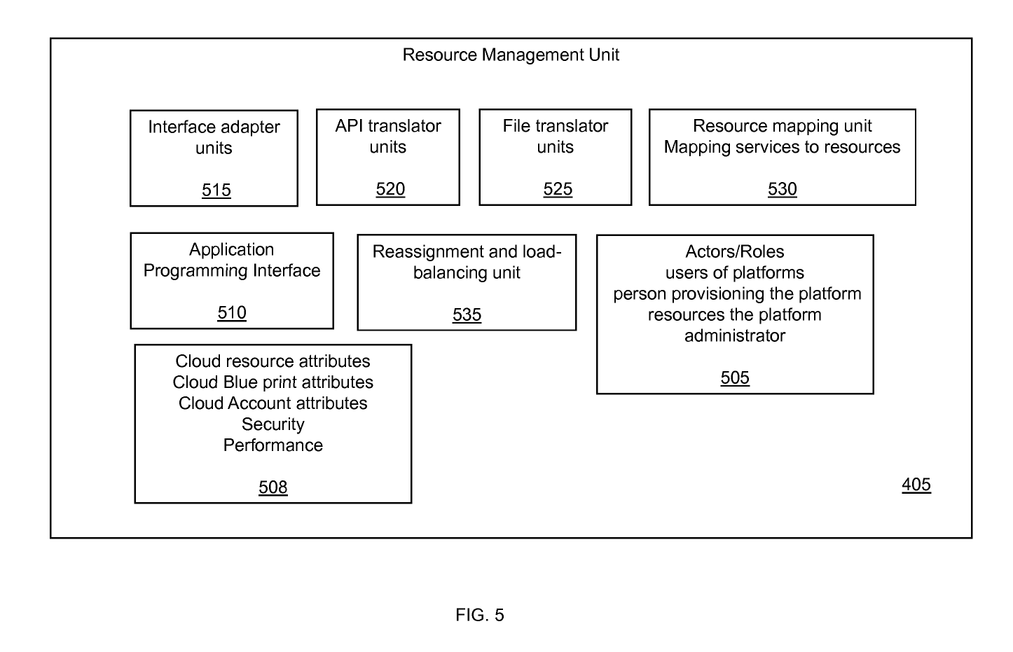

As illustrated in FIG. 5, the cloud resource management unit 405 comprises middleware actor/role attributes 505 that in some embodiments, override the actor/role attributes 320 of any of the multiple attached IT resources 115, multiple attached in-house clouds 125 and multiple attached off-site clouds 135. In some embodiments, the cloud resource management unit 405 comprises middleware attributes 508 that override any of the attributes 305, 310, 315, 330, 335 of any of the multiple attached IT resources 115, multiple attached in-house clouds 125 and multiple attached off-site clouds 135. Therefore, from the central user interface 410 a system administrator is able to manage the actor/role of users and any other attributes of the multiple attached IT resources 115, multiple attached in-house clouds 125 and multiple attached off-site clouds 135 by allowing or denying access of each user 110 to the above resources 115, 125. This allows for the use of group rights in which a group of users 110 can be given or denied rights to one or more of the resources 115, 125, 135. Any other attributes of the in-house clouds 125 can be managed from the cloud resource management unit 405 and the cloud resource management unit 405 provides a consistent interface at central user interface 410 for the attributes 305, 310, 315, 320, 330, 335 of the various platform management units 300. Further, the middleware attributes 508 and the middleware actor/role attributes 505 can be used to automatically configure a newly attached IT resource 115, in-house cloud 125 or off-site clouds 135 before the user 110 are able to use the new cloud. The cloud resource management unit 405 comprises a resource mapping unit 530. The resource mapping unit stores and upon request indicates mapping between middleware actor/role attributes 505 and the actor/role attributes 320 of any of the multiple attached IT resources 115, multiple attached in-house clouds 125 and multiple attached off-site clouds 135. The resource mapping unit 530 also stores mappings between middleware attributes 508 and any of the attributes 305, 310, 315, 330, 335 of any of the multiple attached IT resources 115, multiple attached in-house clouds 125 and multiple attached off-site clouds 135. As discussed in detail below, the resource mapping unit 530 also stores information regarding which of the resources 115, 125, 135 can provide which services, and any necessary conversion or translation units required for a specific resource 115, 125, 135 to provide a specific service. Thus, by updating the resource mapping unit 530 an administrator is able to reconfigure which attributes and services the multiple attached IT resources 115, multiple attached in-house clouds 125 and multiple attached off-site clouds 135 correspond to attributes and services at the corporate IT level.

The above in-house resources 115, 125 can also be stopped, started, maintained, and managed from the central user interface 410. The health of any of the multiple attached IT resources 115, multiple attached in-house clouds 125 and multiple attached off-site clouds 135 can also be monitored from the central user interface 410.

To manage the cloud resource management unit 405 from a point other than the central user interface 410, the cloud resource management unit 405 further comprises middleware APIs 510. The middleware APIs 510 provide all of the functions required for either an administrator acting remotely, or for an automated system to manage the cloud resource management unit 405. The cloud resource management unit 405 also provides middleware APIs that allow applications to use the services provided by the resource management unit.

In some embodiments, the cloud resource management unit 405 merely provides the authorization and centralized management, as discussed above, and the users 110 are free to provision services directly with resources 115, 125, 135 in accordance with rights each user 110 has to access resources 115, 125, 135. In these embodiments, the users 110 use the APIs 325 to obtain services from the in-house clouds 125, as well as other interfaces provided by the IT resources 115, in-house clouds 125 and the off-site clouds 135.

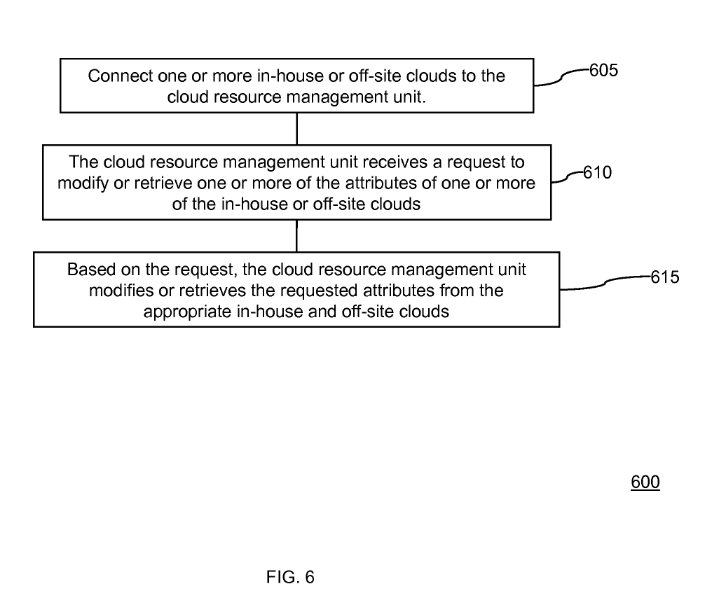

FIG. 6 illustrates an exemplary method 600 of configuring a corporate IT system 400. The method begins at step 605. At step 605 one or more in-house or off-site clouds are connected to the cloud resource management unit 405. The method proceeds to step 610.

At step 610, the cloud resource management unit 405 receives a request to modify or retrieve one or more of the attributes 305, 310, 315, 320, 330, 335 for controlling a service provided by one or more of the in-house or off-site clouds 125, 135. The method proceeds to step 615.

At step 615, based on the request, the cloud resource management unit 405 modifies or retrieves the requested attributes 305, 310, 315, 320, 330, 335 from the appropriate in-house and off-site clouds 125, 135. In some embodiments, the request includes the specific in-house or off-site clouds 125, 135 for which the attributes 305, 310, 315, 320, 330, 335 are to be modified or retrieved. In other embodiments, the request does not include information regarding the specific in-house and off-site clouds 125, 135. The cloud resource management unit 405 based on information stored in the resource mapping unit 530, modifies or retrieves the appropriate attributes in the appropriate in-house or off-site clouds. In this manner, an administrator of the corporate IT system 400 is able to define groups of attributes in the resource mapping unit 530 so that groups of attributes 305, 310, 315, 320, 330, 335 are modified or retrieved simultaneously. The cloud resource management unit 405 may, for example, base the clouds and attributes to be modified on the identity of the user making the request, the particular attributes requested to be modified, the location of the user making the request on a network, a group the user making the request belongs to or the date and time of the request.

In other embodiments, the cloud resource management unit 405 provides services and resources allowing the various resources 115, 125, 135 and users 110 attached to the cloud resource management unit 405 to communicate in a uniform manner.

As illustrated in FIG. 5, in some embodiments, the cloud resource management unit 405 comprises interface adapter units 515, API translator units 520 and file translator units 525. Using the interface adapter units 515, API translator units 520 and file translator units 525 the cloud resource management unit 405 allows a user 110 to perform specific services on the IT resources 115, in-house clouds 125 and off-site clouds 135 using unified APIs provided by the cloud resource management unit 405. Thus, if the user 110 wishes to provision a particular service using one of the resources 115, 125, 135, the user 110 requests the service using a command of the API 510 of the cloud resource management unit 405. The cloud resource management unit 405 uses the API translator units 520 to translate the command of the API 510 into a command for the corresponding resource 115, 125, 135 that is to provide the service. Further, cloud resource management unit 405 also translates any files or data needed to perform the service on the corresponding resource 115, 125, 135 using the file translator units 525. The cloud resource management unit 405 then provisions the service from the resource 115, 125, 135. Any results of the service provisioned are translated using the file translator units 525 and sent back to the user 110. Thus, all of the resources 115, 125, 135 have identical APIs 510 as far as the user is concerned.

Further, any interface adapter units 515 required can be used if the resource is attached on a different interface from the interface expected. Interface adapter units 515 may include, for example, bridges such as ATA or USB over internet protocol.

In the above manner, if appropriate API translator units 520 file translator units 525 and interface adapter units 515 are written for each resource 115, 125, 135 attached to the resource management unit, any service called by a user 110 or application will produce the same result independent of the resource 115, 125, 135 used to perform the service.

In other embodiments, the cloud resource management unit 405 does not perform the translation of APIs files and data. The cloud resource management unit 405, however, upon request provides a terminal or a computer used by the user 110 with the required information for an API translator and file converter in the terminal or the computer used by the user 110 to provide the translations and conversions. The terminal or the computer used by the user 110 is then able to communicate directly with the resource 115, 125, 135 used to provide the service.

Thus, the cloud resource management unit 405 allows the user 110 or application to be unaware and independent of the precise one of the resources used to provide any particular service. Information regarding which of the resources can provide which services, and any necessary conversion or translation units required for a specific resource 115, 125, 135 to provide a specific service are stored in the resource mapping unit 530. When a new resource is added to the corporate IT system the resource mapping unit 530 is updated and any required API translator units 520 interface adapter units 515 or file translator units 525 are added to the cloud resource management unit 405 as necessary.

Because the cloud resource management unit 405 provides the above API translator units 520 interface adapter units 515 and file translator units 525, some services can be provided by multiple ones of the resources 115, 125, 135. This allows the one of the resources 115, 125, 135 used to provide the service to be switched depending on the conditions of the resources 115, 125, 135 in the corporate IT system 400. The cloud resource management unit 405 comprises a reassignment and load-balancing unit 535 to reassign and load-balance the above resources 115, 125, 135 depending upon the current usage. Thus, for example, during the daytime when many users 110 are active the cloud resource management unit 405 may assign applications and users 110 to off-site clouds 135 when the in-house clouds 125 IT and resources 115 are at capacity. In the evening services being provisioned from the off-site clouds 135 can be brought back to the in-house clouds 125 to save the expense of using the and off-site clouds 135, and to fully use the in-house clouds 125 and IT resources 115. The reassignment and load-balancing unit can be configured by an administrator or the user 110 depending upon the rights of the user 110. Further, by monitoring the performance attributes 335 of the above resources 115, 125, 135 the load-balancing unit 535 is able to provision services from resources 115, 125, 135 that are under used and functioning correctly.

If a resource with new technology is attached to the cloud resource management unit 405, new adapters and additional attributes for the resource mapping unit 530 are all that is required for the new technology resource to be accessed by the user 110. The cloud resource management unit 405, thus, speeds the deployment of newly developed resources as well as the deployment of clones of existing resources.

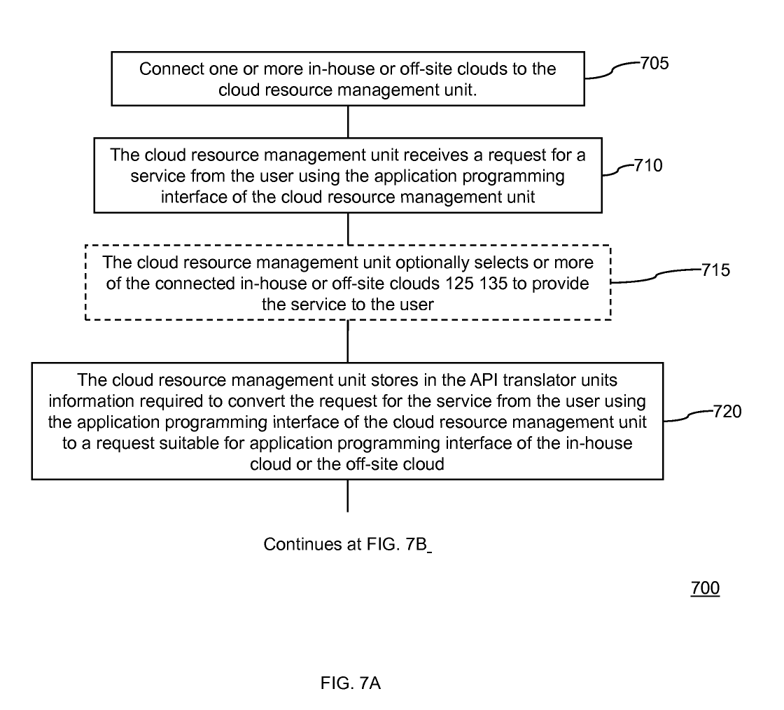

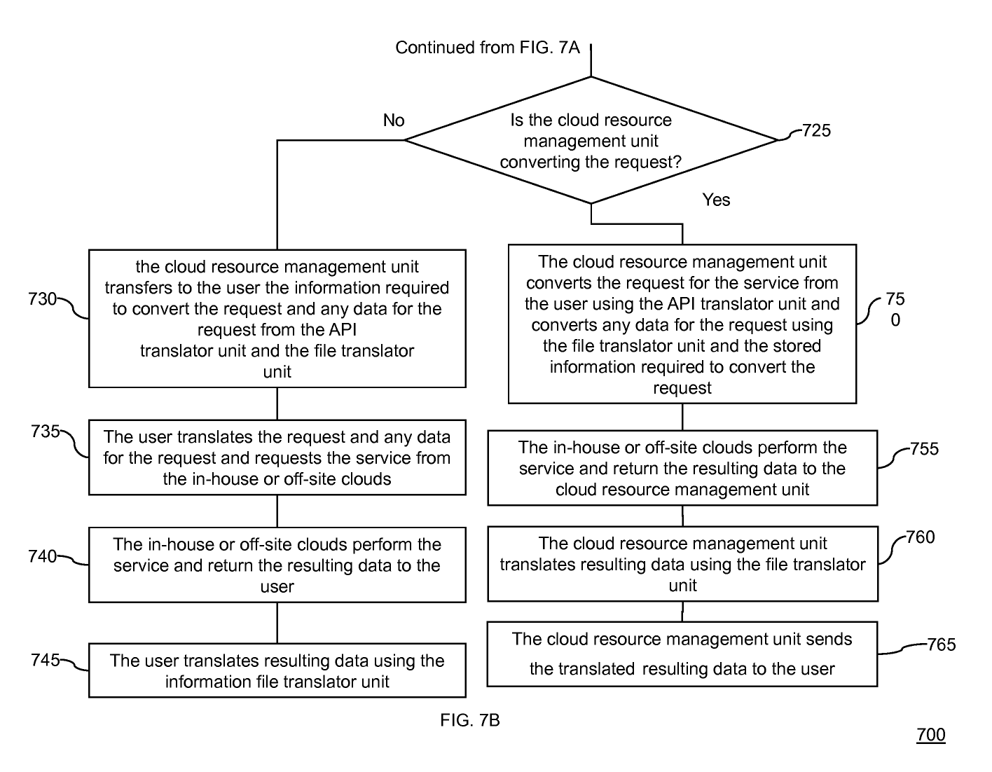

FIG. 7 illustrates a method 700 of providing a service to a user 110 on the corporate IT system 400.

The method begins at step 705. At step 705 one or more in-house or off-site clouds 125, 135 are connected to the cloud resource management unit 405. In some embodiments, the in-house clouds 125 are directly attached to the cloud resource management unit 405 via the network 120. In other embodiments, the in-house clouds 125 are attached to the cloud resource management unit 405 via the network 120, the internet 105 and any other suitable networks. In some embodiments, the off-site clouds 135 are connected to the cloud resource management unit 405 via the Internet 105. In some embodiments, the connection between the cloud resource management unit 405 and the in-house or off-site clouds 125, 135 is via a virtual private network (VPN). After connection, the method proceeds to step 710.

At step 710, the cloud resource management unit 405 receives a request for a service from the user 110 using the application programming interface 510. In some embodiments, the user 110 is directly attached to the cloud resource management unit 405 via the network 120. In other embodiments, the user 110 is attached to the cloud resource management unit 405 via the network 120, the internet 105 and any other suitable networks. In some embodiments, the connection between the user 110 and the cloud resource management unit 405 is via a virtual private network (VPN). After receiving the request, the method proceeds to step 710.

At step 715, in some embodiments the cloud resource management unit 405 optionally selects one or more of the connected in-house or off-site clouds 125, 135 to provide the service to the user. In other embodiments, the user 110 selects the in-house or off-site clouds 125, 135 to provide the service. The resource mapping unit 530 stores information regarding whether the user 110 or the cloud resource management unit 405 selects the resource 125, 135 to provide the service. The method proceeds to step 720.

At step 720, the cloud resource management unit 405 stores, in the API translator unit 520, information required to convert the request for the service from the user 110. Specifically, the API translator unit 520 stores the information required to convert the request for the service using the application programming interface 510 to a request suitable for application programming interface 325 of the in-house cloud 125 or the off-site cloud 135. The method proceeds to step 725.

At step 725, the cloud resource management unit 405 checks if converting the request will be carried out by the cloud resource management unit 405 or the user 110 based on information stored in the resource mapping unit 530. If the conversion is by the user 110 the method proceeds to step 730, else the method proceeds to step 750.

At step 730, the cloud resource management unit 405 transfers to the user 110 the stored information required to convert the request from the API translator unit 520 and the stored information required to convert any data for the request, and any response, from the file translator unit 525. The method proceeds to step 735.

At step 735, the cloud user 110 translates the request and any data for the request and requests the service from the in-house or off-site clouds 125, 135. The method proceeds to step 740.

At step 740, the in-house or off-site clouds 125, 135 perform the service and return the resulting data to the user 110. The method proceeds to step 745.

At step 745, the user 110 translates resulting data using the information from the file translator unit 525, and the method terminates.

At step 750 or, the cloud resource management unit 405 converts the request for the service from the user using the API translator unit 520 and the stored information required to convert the request. The method proceeds to step 755.

At step 755, the in-house or off-site clouds 125, 135 perform the service and return the resulting data to the cloud resource management unit 405. The method proceeds to step 760.

At step 760, the cloud resource management unit 405 translates the resulting data using file translator unit 525. The method proceeds to step 765.

At step 765, the cloud resource management unit 405 sends the translated resulting data to the user, and the method terminates.

As well as the user 110 being provisioned with resources using the cloud resource management unit 405, applications running on the corporate IT system 100 are managed and provisioned with resources using the cloud resource management unit 405. For any particular application running on the corporate IT system 100 access can be allowed or denied to a particular one of the resources 115, 125, 135. Moreover, the cloud resource management unit 405 allows for applications to be defined that span more than one of the resources 115, 125, 135. For example, by using scripting languages running on the cloud resource management unit 405 and one or more of the middleware APIs 510 an application can be written to span more than one of the resources 115, 125, 135. Further, if the application uses APIs 510 to provision services from the resources 115, 125, 135 the cloud resource management unit 405 can request the service from any appropriate one of the resources 115, 125, 135. Thus, the application is able to span the resources 115, 125, 135 without requiring specific knowledge of the services or characteristics of the resources 115, 125, 135. This allows the cloud resource management unit 405 to provide Application as a Service (AAAS) capability, so that an administrator of the corporate IT system 400 is able to associate one of the resources 115, 125, 135 to a specific application. When the ones of the resources 115, 125, 135 have been associated the administrator of the corporate IT system 400 is able to manage at the level of the application and does not need to be concerned with how the application is running on any particular one of the resources 115, 125, 135.

The embodiments described above are intended to be exemplary. One skilled in the art recognizes that numerous alternative components and embodiments that may be substituted for the particular examples described herein and still fall within the scope of the invention.

What is claimed is:

1. An information technology system comprising:
a cloud resource management unit comprising a first interface;
at least one cloud connected to the cloud resource management unit, each cloud comprising a corresponding second interface adapted to provide a service to a user of the information technology system; and
the cloud resource management unit further comprising a first storage unit adapted to store first information required to convert a request for the service from the user in the first interface into a request suitable for the corresponding second interface of the at least one cloud.

2. The information technology system according to claim 1, wherein the at least one cloud is directly attached to the cloud resource management unit by a private network.

3. The information technology system according to claim 1, wherein the at least one cloud is attached to the cloud resource management unit via the Internet.

4. The information technology system according to claim 1, wherein the user is directly attached to the cloud resource management unit by a private network.

5. The information technology system according to claim 1, the cloud resource management unit further comprising a conversion unit adapted to convert the request for the service from the user in the first interface to the request suitable for the second interface of the corresponding at least one cloud, the conversion based on information in the first storage unit.

6. The information technology system according to claim 1, wherein the cloud resource management unit is adapted to transfer the information required to convert the request for the service from the user in the first interface to a request suitable for the second interface of the corresponding at least one cloud to the user when the user requests the service.

7. The information technology system according to claim 5, the at least one cloud comprising at least two clouds and the cloud resource management unit further comprising a selection unit adapted to select a one or more of the at least two clouds to provide the service to the user.

8. The information technology system according to claim 1, the cloud resource management unit further comprising a second storage unit adapted to store second information required to convert first data from a format generated by the user to a format suitable for the corresponding at least one cloud or to convert second data from a format generated by the corresponding at least one cloud to a format suitable for a user.

9. The information technology system according to claim 8, the cloud resource management unit further comprising a conversion unit adapted to convert the first data from the format generated by the user to the format suitable for the corresponding at least one cloud or to convert the second data from the format generated by the corresponding at least one cloud to the format suitable for the user, based on the second information.

10. The information technology system according to claim 8, wherein the cloud resource management unit is adapted to transfer the second information from the second storage unit to the user when the user requests a service requiring the first data.

11. A method of providing a service on an information technology system comprising:
connecting at least one cloud to a cloud resource management unit;
the cloud resource management unit receiving a request for a service from a user using a first interface; and
the cloud resource management unit storing first information required to convert the request for the service from the user using the first interface to a request suitable for a second interface of the corresponding at least one cloud to provide the service.

12. The method according to claim 11, wherein the at least one cloud is directly attached to the cloud resource management unit via a private network.

13. The method according to claim 11, wherein the at least one cloud is attached to the cloud resource management unit via the Internet.

14. The method according to claim 11, further comprising directly attaching the user to the cloud resource management unit via a private network.

15. The method according to claim 11, the method further comprising the cloud resource management unit converting the request for the service from the user using the first interface to the request suitable for the second interface of the corresponding at least one cloud based on the stored first information.

16. The method according to claim 11, the method further comprising the cloud resource management unit transferring the information required to convert the request for the service from the user in the first interface to a request suitable for the second interface of the corresponding at least one cloud to the user when the user requests the service.

17. The method according to claim 15, the at least one cloud comprising at least two clouds and the cloud resource management unit selecting one or more of the at least two clouds to provide the service to the user.

18. The method according to claim 11, the method further comprising the cloud resource management unit storing second information required to convert data from a format generated by the user to a format suitable for the corresponding at least one cloud.

19. The method according to claim 18, wherein the cloud resource management unit converts the data from the format generated by the user to a format suitable for the corresponding at least one cloud based on the second information.

20. The method according to claim 18, the method further comprising the cloud resource management unit transferring the second information from the cloud resource management unit to the user.
